(19) United States
(12) Patent Application Publication
(10) Pub. No.: US 2018/0006726 A1
(43) Pub. Date: Jan. 4, 2018

(54) OPTICAL DISTRIBUTION NETWORK INCLUDING OPTICAL CABLE AND OPTICAL NODE, AND OPERATING METHOD THEREOF

(71) Applicant: ELECTRONICS AND TELECOMMUNICATIONS RESEARCH INSTITUTE, Daejeon (KR)

(72) Inventors: Jae In KIM, Gwangju (KR); Geun Yong KIM, Gwangju (KR); Hee Do KIM, Seoul (KR); Byung Hee SON, Gwangju (KR); Moon Kyun OH, Daejeon (KR); Hark YOO, Gwangju (KR); Dong Soo LEE, Yongin (KR); Hyun Seo KANG, Gwangju (KR); Gi Ha YOON, Seongjeon-myeon (KR)

(21) Appl. No.: 15/638,104

(22) Filed: Jun. 29, 2017

(30) Foreign Application Priority Data
Jul. 1, 2016 (KR) 10-2016-0083400
Jun. 13, 2017 (KR) 10-2017-0074020

(51) Int. Cl. H04B 10/27; G02B 6/42; H04B 10/079

(52) U.S. Cl. CPC H04B 10/27; H04B 10/07955; G02B 6/428; G02B 6/4298

(57) ABSTRACT

Provided is an optical distribution network (ODN) including an optical cable and an optical node, and more particularly, an optical distribution network including an optical cable and an optical node, wherein the optical node is implemented to acquire and analyze information regarding the optical cable through an optical connector included in the optical cable, and an operating method thereof. The ODN includes an optical cable and an optical node connectable to the optical cable, wherein the optical cable has an optical connector capable of being joined to the optical node, and the optical connector has an electronic tag configured to store identification information of the optical cable and a first connection pin configured to electrically connect the electronic tag and the optical node.

### CROSS-REFERENCE TO RELATED APPLICATION

This application claims priority to and the benefit of Korean Patent Application No. 10-2016-0083400, filed on Jul. 1, 2016 and Korean Patent Application No. 10-2017-0074020, filed on Jun. 13, 2017, the disclosure of which is incorporated herein by reference in its entirety.

### BACKGROUND

### 1. Field

The present invention relates to an optical distribution network (ODN) including an optical cable and an optical node, and more particularly, to an optical distribution including an optical cable and an optical node and implemented such that the optical node acquires and analyzes information regarding the optical cable through an optical connector provided at the optical cable, and an operating method thereof.

### 2. Discussion of Related Art

In passive optical network (PON) technology, an optical node (e.g., an optical splitter, an optical patch panel, etc.) of a conventional optical distribution network (ODN) is composed of only passive elements, and thus cannot automatically acquire connection information and status information of a plurality of subscriber sections.

Currently, connection information regarding a port of an optical node and a connector of an optical cable is managed using a paper label adhered to the optical cable and port information (e.g., a line number sheet) is noted the optical node. This information is managed as a general electronic document such as a spreadsheet. When the connection information of the ODN is managed in this way, there is difficulty in accurately maintaining the connection information of the ODN because of a change in contract or service between an optical network subscriber and an optical network service provider, and optical infrastructure resources are wasted or maintenance costs are increased due to inaccurate connection information.

In order to solve the aforementioned problem, a technology for automatically acquiring ODN connection information, such as radio-frequency identification (RFID), a quick response (QR) Code, or the like, is applied to the optical node and the optical connector. However, it is difficult to actually apply the technology due to a high cost relative to conventional passive components.

Also, optical time-domain reflectometer (OTDR) technology is utilized to acquire status information regarding an optical cable, such as cutting, bending, cracking, and deterioration. However, in the case of South Korea, the technology is not widely used to actually manage networks because associated apparatuses are too expensive.

A commercial OTDR apparatus is composed of very precise expensive components, and thus can acquire optical infrastructure status information of all sections ranging from an optical line terminal of a base station to an optical network terminal (ONT) of a subscriber (in a range of several to 250 Km). However, as a distance and a degree of branching of an ODN increases (e.g. 2 stages and 64 branches), it is actually impossible to acquire information regarding a group of subscribers (a Drop section, which is a section from a 2-stage branch point to a subscriber optical network terminal (ONT)) in spite of good performance of a commercial OTDR apparatus.

Because of such problems, there is a need for an apparatus for acquiring low level state information (whether there is an optical signal, whether an ONT is connected, etc.) of an optical cable connected to an optical node at a 2-stage branch point instead of a need for an expensive OTDR apparatus.

### SUMMARY

Accordingly, the present invention has been devised to solve the aforementioned problems, and the present invention is directed to providing an optical distribution network (ODN) including an optical cable and an optical node in which the optical node is implemented to acquire and analyze information regarding the optical cable through an optical connector included in the optical cable, and an operating method thereof.

According to an aspect of the present invention, there is provided an ODN including an optical cable and an optical node connectable to the optical cable. The optical cable has an optical connector capable being joined to the optical node, and the optical connector has an electronic tag configured to store identification information of the optical cable and a first connection pin configured to electrically connect the electronic tag and the optical node.

The electronic tag and the first connection pin may be directly formed in a body of the optical connector.

The electronic tag and the first connection pin may be formed in the optical connector by adhering an auxiliary object having the electronic tag and the first connection pin formed therein to a body of the optical connector.

The optical node may include an optical adaptor capable of being joined to the optical connector; and a processing module configured to determine a state of the optical cable using at least one of the identification information of the optical cable having the optical connector capable of being joined to the optical adaptor, optical signal presence/absence information, and optical power information.

The optical adaptor may include a second connection pin connectable to the first connection pin at one end thereof; and a connection part connected to the other end of the second connection pin at one end thereof and connected to the processing module at the other end thereof.

The processing module may include at least one recognition module connected to the optical adaptor and configured to acquire the identification information of the optical cable from the optical connector joined to the optical adaptor; a monitoring module configured to acquire optical signal presence/absence information of the optical cable connected through the optical adaptor and measure the optical power information; and a central processing module configured to determine the state of the optical cable using at least one of the identification information, the optical signal presence/absence information, and the optical power information.

The central processing module may compare current identification information with predetermined identification information, determine that the current state of the optical cable is normal when the current identification information and the predetermined identification information are the same, acquire a history of changes of a subscriber and an optical cable from a central management server when the current identification information and the predetermined identification information are not the same, determine that the optical cable is normally changed when the current identification information and identification information included in the history of changes are the same, and determine that the current state of the optical cable is abnormal when the current identification information and identification information included in the history of changes are not the same.

The central processing module may compare the measured optical power information with optical power information for each state and determine the current state of the optical cable.

The central processing module may determine whether the current state of the optical cable is normal, whether a subscriber terminal device is connected to the optical cable but is powered off, whether a subscriber terminal device is not connected to the optical cable, or whether the optical cable is cut or bent by comparing the measured optical power information with the optical power information for each state.

The central processing module may compare the acquired optical signal presence/absence information with previous optical signal presence/absence information, acquire a history of changes of a subscriber and an optical cable from a central management server when the acquired optical signal presence/absence information and the previous optical signal presence/absence information are the same, determine that a subscriber is changed but a previous port is used when there is a subscriber change, and determine that the optical cable is normal when there is no subscriber change.

The central processing module may compare the acquired optical signal presence/absence information with the previous optical signal presence/absence information, acquire the history of changes of a subscriber and an optical cable from the central management server when the acquired optical signal presence/absence information and the previous optical signal presence/absence information are not the same, determine that the acquired optical signal presence/absence information is changed when there is a subscriber change, and determine that the optical cable is abnormal when there is no subscriber change.

The optical adaptor may include a space formed at any one surface of a body of the optical adaptor to which the optical connector is to be joined; and a circuit board having a second connection pin installed therein and having a wire configured to electrically connect the second connection pin and the processing module, and the circuit board may be adhered to the body of the optical adaptor so that the second connection pin is positioned in the space.

The optical connector may include a body; and a housing coupled to the body and capable of being joined to the optical adaptor, and the electronic tag and the first connection pin may be formed in the housing.

According to another aspect of the present invention, there is provided an operating method of an ODN including an optical cable and an optical node connectable to the optical cable, the operating method including: acquiring information regarding the optical cable while the optical cable is joined to the optical node, by a processing module of the optical node; comparing the acquired information regarding the optical cable with previous information regarding the optical cable and determining a current state of the optical cable, by the processing module; and providing the acquired information regarding the optical cable and a result of the determination to a central management server or a predetermined external portable device that is linked with the optical node, by the processing module.

The acquiring of information regarding the optical cable may include acquiring identification information of the optical cable, by the processing module, and the determining of a current state of the optical cable may include comparing current identification information with predetermined identification information and determining that the current state of the optical cable is normal when the current identification information and the predetermined identification information are the same.

The determining of a current state of the optical cable may include acquiring a history of changes of a subscriber and an optical cable from the central management server when the current identification information and the predetermined identification information are not the same, determining that the optical cable is normally changed when the current identification information and identification information included in the history of changes are the same, and determining that the current state of the optical cable is abnormal when the current identification information and identification information included in the history of changes are not the same.

The acquiring of information regarding the optical cable may include acquiring optical signal presence/absence information for the optical cable, by the processing module, and the determining of a current state of the optical cable may include comparing the acquired optical signal presence/absence information with previous optical signal presence/absence information, acquiring a history of changes of a subscriber and an optical cable from a central management server when the acquired optical signal presence/absence information and the previous optical signal presence/absence information are the same, determining that a subscriber is changed but a previous port is used when there is a subscriber change, and determining that the optical cable is normal when there is no subscriber change.

The determining of a current state of the optical cable may include comparing the acquired optical signal presence/absence information with the previous optical signal presence/absence information, acquiring the history of changes of a subscriber and an optical cable from the central management server when the acquired optical signal presence/absence information and the previous optical signal presence/absence information are not the same, determining that the acquired optical signal presence/absence information is changed when there is a subscriber change, and determining that the optical cable is abnormal when there is no subscriber change.

The acquiring of information regarding the optical cable may include measuring optical power information for the optical cable, by the processing module, and the determining of a current state of the optical cable may include comparing the measured optical power information with optical power information for each state to determine the current state of the optical cable.

The determining of a current state of the optical cable may include determining whether the current state of the optical cable is normal, whether a subscriber terminal device is connected to the optical cable but is powered off, whether a subscriber terminal device is not connected to the optical cable, or whether the optical cable is cut or bent by comparing the measured optical power information with the optical power information for each state.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram schematically showing a pre-joining state of an optical node provided with an optical adaptor and an optical cable provided with an optical connector according to an embodiment of the present invention;

FIG. 2 is a diagram showing an example of an integrated optical connector according to an embodiment of the present invention;

FIG. 3 is a diagram showing an example of a pre-coupling state of a couplable optical connector according to an embodiment of the present invention;

FIG. 4 is a diagram showing an example of an optical adaptor according to an embodiment of the present invention;

FIG. 5 is a diagram showing a pre-joining state of an optical connector and an optical adaptor according to an embodiment of the present invention;

FIG. 6 is a diagram showing another example in which an optical adaptor is implemented according to an embodiment of the present invention;

FIG. 7 is a diagram showing an example in which the optical adaptor shown in FIG. 6 is implemented as a plurality;

FIGS. 8A and 8B show a structure in which an optical adaptor and an optical connector are connected via a housing in an SC type, FIG. 8A shows a pre-joining state thereof viewed from a top surface, and FIG. 8B shows the pre-joining state viewed from a bottom surface;

FIGS. 9A and 9B show a structure in which an optical adaptor and an optical connector are connected via a housing in an LC type, FIG. 9A shows a pre-joining state thereof viewed from a top surface, and FIG. 9B shows the pre-joining state viewed from a bottom surface;

FIG. 10 is a diagram showing a configuration of a processing module of an optical node according to an embodiment of the present invention;

FIG. 11 is a flowchart showing a procedure of analyzing a current state of an optical cable on the basis of information acquired by a recognition module of an optical node according to an embodiment of the present invention;

FIG. 12 is a flowchart showing a procedure of analyzing a current state of an optical cable on the basis of optical power information acquired by a monitoring module of an optical node according to an embodiment of the present invention; and

FIGS. 13A and 13B are flowcharts showing a procedure of analyzing a current state of an optical cable on the basis of optical signal presence/absence information acquired by a monitoring module of an optical node according to an embodiment of the present invention.

### DETAILED DESCRIPTION OF EXEMPLARY EMBODIMENTS

Specific structural and functional details disclosed herein are merely representative for the purpose of describing example embodiments. However, the present invention may be embodied in many alternate forms and is not to be construed as being limited to only the example embodiments set forth herein.

Accordingly, while example embodiments of the invention are capable of various modifications and alternative forms, the embodiments thereof are shown by way of example in the drawings and will herein be described in detail. However, it should be understood that there is no intent to limit example embodiments of the present invention to the particular forms disclosed. Conversely, example embodiments are to cover all modifications, equivalents, and alternatives falling within the scope of the invention.

It should be understood that, although the terms first, second, etc. may be used herein to describe various elements, these elements are not limited by these terms. These terms are only used to distinguish one element from another. For example, a first element could be termed a second element, and, similarly, a second element could be termed a first element, without departing from the scope of example embodiments of the present invention.

It should be understood that when an element is referred to as being “connected” or “coupled” to another element, the element can be directly connected or coupled to the other element or intervening elements may be present. Conversely, when an element is referred to as being “directly connected” or “directly coupled” to another element, there are no intervening elements present. Other words used to describe a relationship between elements should be interpreted in a like fashion (e.g., “between” versus “directly between,” “adjacent” versus “directly adjacent,” etc.).

The terminology used herein is for the purpose of describing particular embodiments only and is not intended to limit the example embodiments of the invention. As used herein, the singular forms “a,” “an,” and “the” are intended to include the plural forms as well unless the context clearly indicates otherwise. It should be further understood that the terms “comprises,” “comprising,” “includes,” “including,” “has,” and/or “having,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It should be further understood that terms, e.g., those defined in commonly used dictionaries, should be interpreted as having a meaning that is consistent with their meaning in the context of the relevant art and are not to be interpreted in an idealized or overly formal sense unless expressly so defined herein.

It should also be noted that, in some alternative implementations, functions/acts noted in a specific block may occur out of the order noted in a flowchart. For example, two blocks shown in succession may in fact be executed substantially concurrently or may sometimes be executed in a reverse order depending upon functionality/acts involved.

Hereinafter, an optical distribution network (ODN) including an optical cable and an optical node and an operating method thereof according to an embodiment of the present invention will be described in detail with reference to the accompanying drawings.

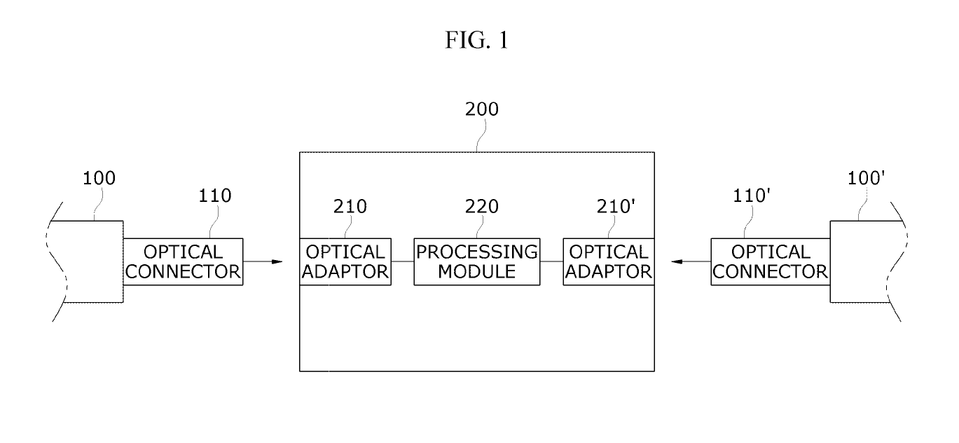

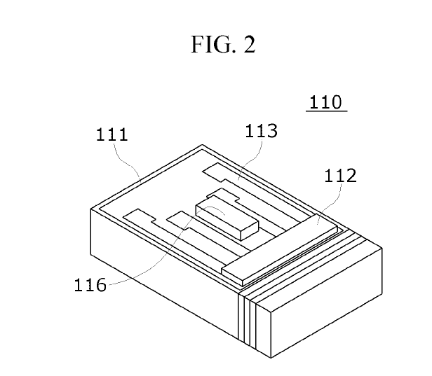

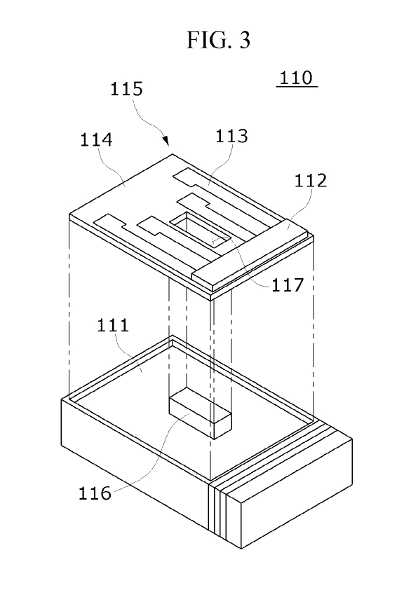

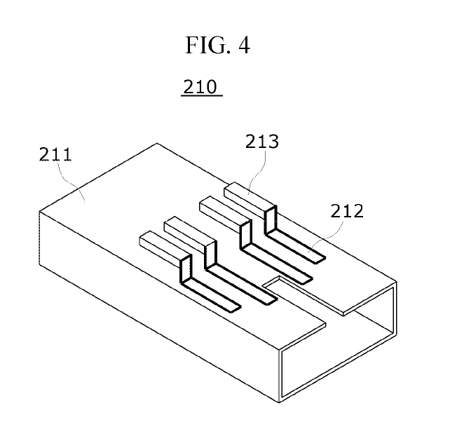

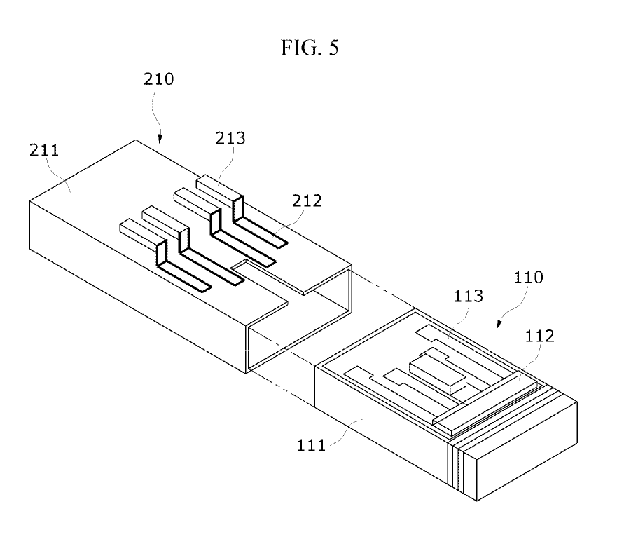

FIG. 1 is a diagram schematically showing a pre-joining state of an optical node provided with an optical adaptor and an optical cable provided with an optical connector according to an embodiment of the present invention, FIG. 2 is a diagram showing an example of an integrated optical connector according to an embodiment of the present invention, FIG. 3 is a diagram showing an example of a pre-coupling state of a couplable optical connector according to an embodiment of the present invention, FIG. 4 is a diagram showing an example of an optical adaptor according to an embodiment of the present invention, and FIG. 5 is a diagram showing a pre-joining state of an optical connector and an optical adaptor according to an embodiment of the present invention.

Referring to FIGS. 1 to 5, optical cables 100 and 100′ have optical connectors 110 and 110′, respectively, and an optical node 200 has optical adaptors 210 and 210′ and a processing module 220.

In this case, the optical cable 100 is connected to the optical node 200 by the optical connector 110 being joined to the optical adaptor 210, and the optical cable 100′ is connected to the optical node 200 by the optical connector 110′ being joined to the optical adaptor 210′.

Since the optical cable 100 connected to a subscriber terminal device (e.g., an optical network terminal (ONT)), which is a subscriber-side optical cable, and the optical cable 100′ connected to a service provider (e.g., an OLT), which is a provider-side optical cable, are joined to the optical node 200, the optical node 200 has the two optical adaptors 210 and 210′ which form a pair.

Also, since the optical node 200 has different branching functions depending on uses thereof, such as 1×4, 1×8, 1×16, 16×16, and 32×32, the number of optical cables connected to the optical node 200 may change depending on the branching functions.

In this case, the optical connector 110 and the optical adaptor 210 have the same structures as the optical connector 110′ and the optical adaptor 210′, respectively.

Therefore, the structure of the optical connector 110 and the structure of the optical adaptor 210 will be mainly described.

First, the optical connector 110, which is included in the optical cable 100 and capable of being joined to the optical adaptor 210 of the optical node 200, will be described.

The optical connector 110 is provided on the optical cable 100 connected to the optical node 200. An electronic tag 112 configured to store identification information and a first connection pin 113 configured to electrically connect the electronic tag 112 and other elements (e.g., an optical connector of an optical node) are formed in a body 111 of the optical connector 110.

The identification information stored in the electronic tag 112 may be identification information for an optical cable or identification information for an optical connector.

Also, the electronic tag 112 includes a memory, for example, an electrically erasable programmable read-only memory (EEPROM). However, the present invention is not limited thereto, and the electronic tag 112 may include a dynamic random access memory (DRAM), a ferroelectric RAM (FeRAM), a Phase-change RAM (PRAM), a Resistive RAM (RRAM), a magnetoresistive RAM (MRAM), etc.

The first connection pin 113 has one end connected to the electronic tag 112 and the other end exposed to the outside. In this case, the first connection pin 113 may be connected to the electronic tag 112 through various ways such as bonding and soldering.

Also, the number of first connection pins 113 may be appropriately selected according to a specification of the electronic tag 112, and a shape and position of the first connection pin 113 may be variously implemented according to a structure of the optical adaptor.

For example, the optical connector 110 may have four first connection pins 113, which may be a power supply (+) pin, a ground pin, a data transmission pin, and a data reception pin.

As another example, when the electronic tag 112 may be accessed with two connection pins, the optical connector 110 may have two first connection pins 113.

Also, a length, shape, and thickness of the first connection pin 113 may be set to be various values.

In this case, since the electronic tag 112 is operated by an electric signal, a first connection pin for power supply and a first connection pin for data may be implemented to have different lengths in order to protect the electronic tag 112.

Specifically, by forming the first connection pin for power supply to be longer than the first connection pin for data, the first connection pin for data may be joined to a target (e.g., a second connection pin for data) after the first connection pin for power supply is joined to a target (e.g., a second connection pin for power supply).

Also, the first connection pin 113, which is used for electric connection, may be made of any conductive material. For example, the first connection pin 113 may be made of a metal material or made of an insulation material plated with a conductive material.

As shown in FIG. 2, the electronic tag 112 and the first connection pin 113 may be directly formed on the body 111.

In this case, the first connection pin 113 may be implemented through various methods such as plating or double injection and may be connected to the electronic tag 112 through various adhesion methods such as bonding and soldering.

However, as shown in FIG. 3, an auxiliary object 115 on which the electronic tag 112 and the first connection pin 113 are formed may be separately implemented on a base 114, which is made of an insulating material, and the optical connector 110 may be implemented with the auxiliary object 115 being adhered to the body 111.

Here, the base 114 should be formed to a sufficiently small thickness and be firmly adhered to the body 111 so that the optical connector 110 is not damaged when the optical connector 110 is joined to the optical adaptor 210. For example, the base 114 may be made of a PCB, FPCB, or PCV film.

In consideration of productivity and production costs, the optical connector 110 including the auxiliary object 115 may be joined to the optical adaptor 210 without being damaged due to the optical adaptor 210 being partially modified when the base 114 is thick.

In addition, as shown in FIGS. 2 and 3, a protrusion part 116 may be formed on the optical connector 110 so that the optical connector 110 is accurately coupled to the optical adaptor 210 and stably fastened after the coupling.

In particular, as shown in FIG. 3, when the optical connector 110 is implemented by the body 111 being adhered to the auxiliary object 115, the protrusion part 116 is formed on the body 111 and a hole 117 is coupled to the protrusion part 116.

Next, the optical adaptor 210, which is capable of being joined to the optical connector 110 of the optical cable, and the optical node 200 including the processing module 220 will be described.

According to an embodiment of the present invention, the optical adaptor 210 is connected to the optical connector 110 and installed in the optical node 200.

A second connection pin 212, which is connected to the first connection pin 113 of the optical connector 110, is formed on a body 211 of the optical adaptor 210.

In this case, the second connection pin 212 is made of a conductive metal material and may be formed using a molding method such as double injection to be adhered to the body 211.

A shape and position of the second connection pin 212 may be appropriately selected to match the first connection pin 113 of the optical connector 110. The second connection pin 212 may be formed on any one of four surfaces of the body 211.

Also, a connection part 213 for connecting with the processing module 220 is formed on the body 211.

The connection part 213 is connected to the second connection pin 212 at an end thereof, and the number of connection parts 213 corresponds to the number of second connection pins 212.

In this case, the connection part 213 may be formed on a surface on which the second connection pin 212 is formed. Alternatively, the connection part 213 may be formed on a surface other than the surface on which the second connection pin 212 is formed.

When the optical adaptor 210 is joined to the optical connector 110 in this way, the second connection pin 212 may be connected to the first connection pin 113, and the processing module 220 connected thereto through the connection part 213 may search the electronic tag 112 of the optical connector 110 for identification information.

Also, the processing module 220 may also acquire information regarding whether the optical cable 100 is joined to the optical node 200 by the first connection pin 113 being brought into contact with the second connection pin 212.

The processing module 220 is composed of various kinds of electronic devices for performing functions, and is electrically connected to the optical adaptors 210 and 210′.

The processing module 220 will be described later.

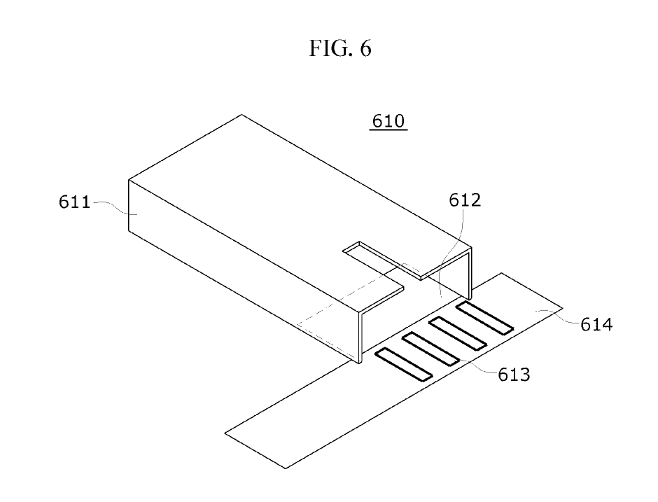

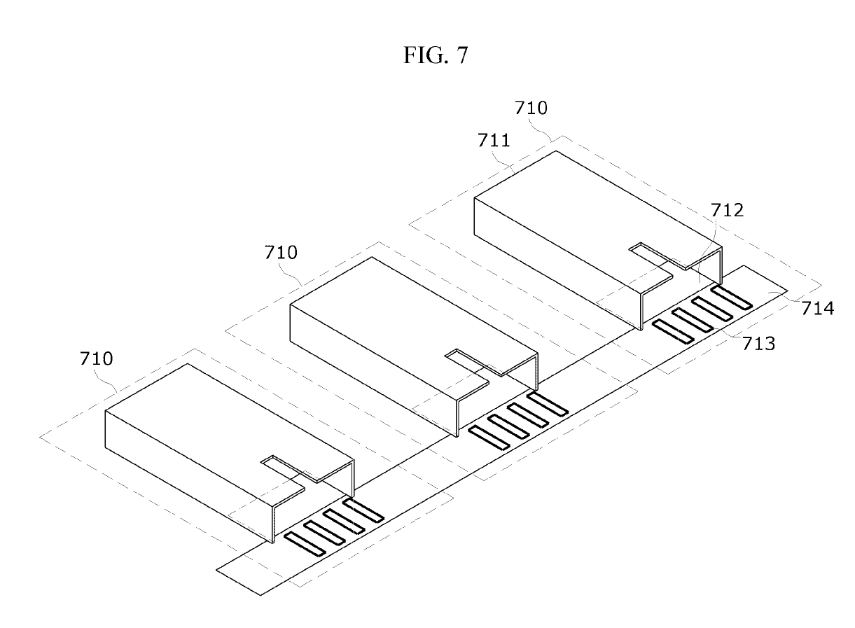

The structure of the optical adaptor will be described in detail below with reference to FIGS. 6 and 7.

FIG. 6 is a diagram showing another example in which an optical adaptor is implemented according to an embodiment of the present invention.

As shown in FIG. 6, a space 612 is formed in a body 611 by partially removing any one surface (a bottom surface in FIG. 6) of the body 611 to which an optical connector 610 will be joined. Accordingly, even when the optical connector is thick, the optical connector may be easily joined to an optical adaptor 610.

When the space 612 is formed in the body 611 as shown in FIG. 6, a second connection pin 613 to be connected to the first connection pin 113 of the optical connector 110 shown in FIGS. 2 and 3 may be designed to be positioned in the space 612.

For example, in this case, in order to position the second connection pin 613 in the space 612, the second connection pin 613 may be installed in a circuit board 614 in which a wire configured to electrically connect the second connection pin 613 and the processing module 220 of FIG. 1 is formed, and the circuit board 614 may be adhered to the body 611 so that the second connection pin 613 is positioned in the space 612.

As shown in FIG. 6, when the optical adaptor 610 is implemented by an application of the circuit board 614 in which the second connection pin 613 is installed, it is possible to implement a plurality of optical adaptors and it is also possible to reduce production costs in comparison to the optical adaptor implemented as shown in FIG. 4.

FIG. 7 shows an example the optical adaptor of FIG. 6 is provided as a plurality.

Also, when optical adaptors are implemented as shown in FIG. 6, a light emitting device (LED) for displaying a connection state of an optical connector and each of the optical adaptors may be installed in the circuit board 614 to correspond to each of the optical adaptors.

A structure in which an adaptor and an optical connector are connected while an electronic tag and a first connection pin are directly formed on a body of the optical connector has been described above. A structure in which the optical adaptor and the optical connector are connected by a medium will be described below.

As will be described below, it is possible to use pre-installed conventional optical cables as they are without replacement when an optical adaptor and an optical connector are connected by a medium. It is also possible to manage IDs without replacement by using a medium with an optical connector to which an electronic tag is adhered.

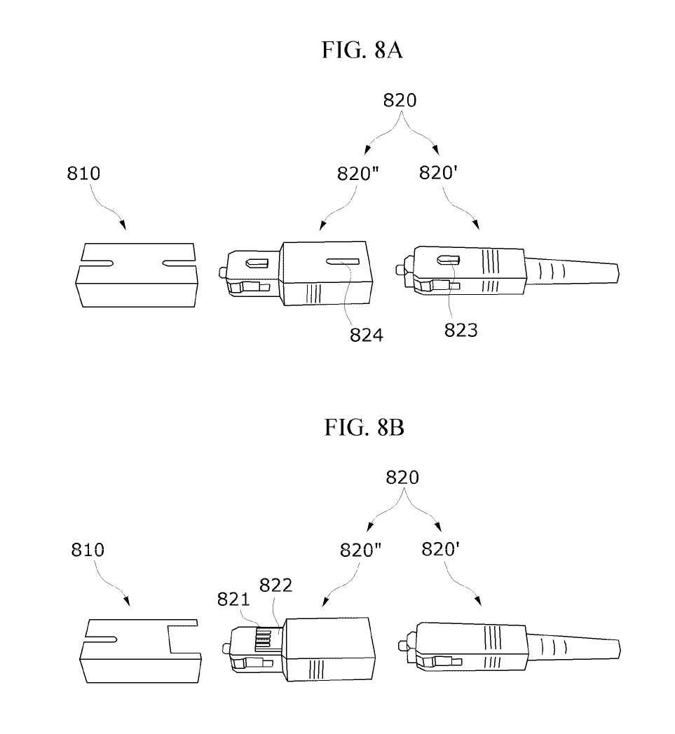

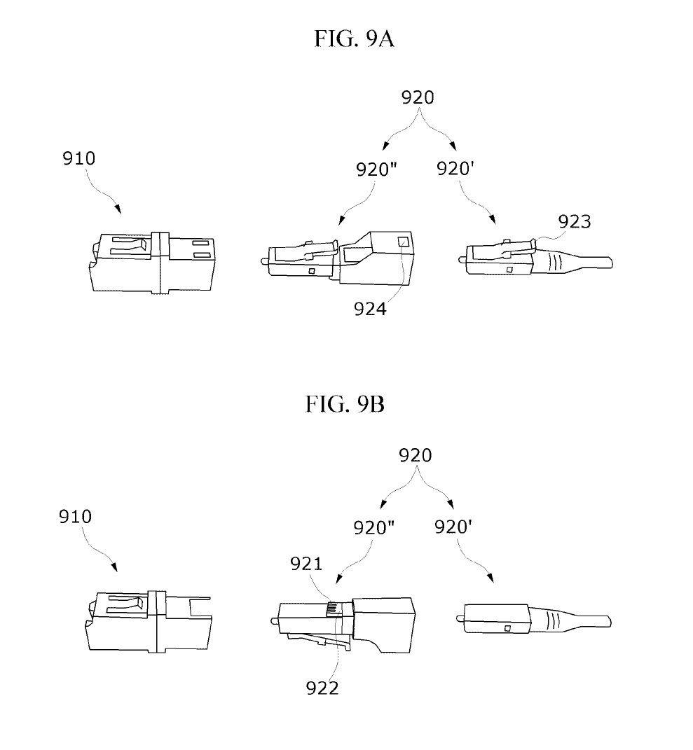

FIG. 8 shows an example in which an optical adaptor and an optical connector are connected via a medium according to an embodiment of the present invention, and FIG. 9 shows another example in which an optical adaptor and an optical connector are connected via a medium according to an embodiment of the present invention.

FIG. 8 shows a structure in which an optical adaptor and an optical connector are connected via a housing in an SC type. FIG. 8A shows a pre-joining state thereof viewed from a top surface, and FIG. 8B shows the pre-joining state viewed from a bottom surface.

As shown in FIG. 8, an optical connector 820 is composed of a body 820′ and a housing 820″. The body 820′ is coupled to the housing 820″, and the housing 820″ is coupled to an optical adaptor 810.

In this case, an electronic tag and a first connection pin, as shown in FIG. 2, are installed in the housing 820″, and FIG. 8B shows a state in which a first connection pin 821 and an electronic tag 822 are installed on a bottom surface of the housing 820″.

In order to strengthen the coupling between the body 820′ and the housing 820″, the body 820′ may be joined to the housing 820″ by a hook coupling method.

For example, the body 820′ is provided with a hook 823, and the housing 820″ is provided with a groove 824. The body 820′ may be coupled to the housing 820″ by the hook 823 being joined to the groove 824.

FIG. 9 shows a structure in which an optical adaptor and an optical connector are connected via a housing in an LC type. FIG. 9A shows a pre-joining state thereof viewed from a top surface, and FIG. 9B shows the pre-joining state viewed from a bottom surface.

As shown in FIG. 9, an optical connector 920 is composed of a body 920′ and a housing 920″. The body 920′ is coupled to the housing 920″, and the housing 920″ is coupled to an optical adaptor 910.

In this case, an electronic tag and a first connection pin, as shown in FIG. 2, are installed in the housing 920″, and FIG. 9B shows a state in which a first connection pin 921 and an electronic tag 922 are installed on a bottom surface of the housing 920″.

In order to strengthen the coupling between the body 920′ and the housing 920″, the body 920′ may be joined to the housing 920″ by a hook coupling method.

For example, the body 920′ is provided with a hook 923, and the housing 920″ is provided with a groove 924. The body 920′ may be coupled to the housing 920″ by the hook 923 being joined to the groove 924.

As can be seen from FIGS. 8 and 9, the bodies 820′ and 920′ are coupled to the housings 820″ and 920″, respectively. The housings 820″ and 920″ are formed to have structures similar to those of the bodies 820′ and 920′ so that the bodies 820′ and 920′ may be coupled to the housings 820″ and 920″.

In particular, it is preferable that front end parts of the housings 820″ and 920″ be formed in shapes similar to those of the bodies 820′ and 920′ so that the housings 820″ and 920″ may be coupled to the optical adaptors 810 and 910, respectively.

Also, since the housings 820″ and 920″ have enough space to be provided with an additional element, the housings 820″ and 920″ may further include an additional electronic circuit, for example, a display device such as an LED.

In this case, the additional electric circuit may be integrally implemented with the electronic tag. When a display device such as an LED is implemented in the housings 820″ and 920″, the display device may display information regarding whether the electronic tag is joined to the housings 820″ and 920″, information regarding whether the optical adaptor is joined to the optical connector, etc.

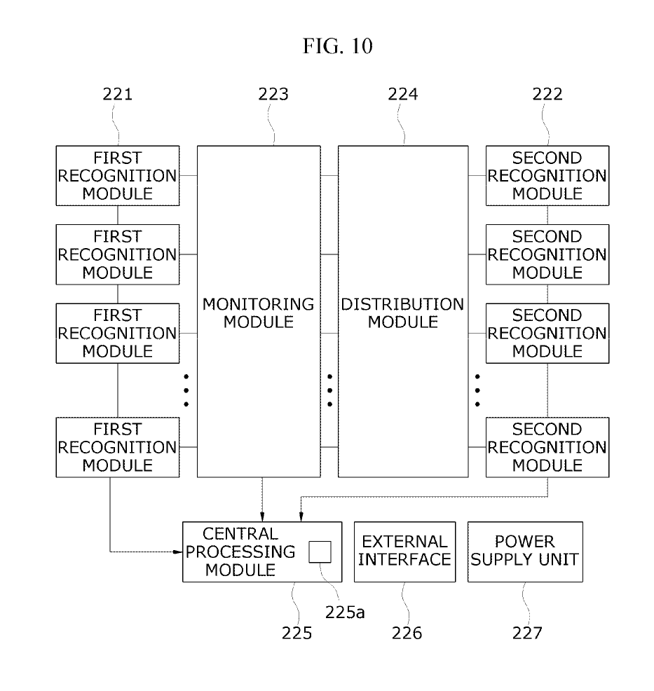

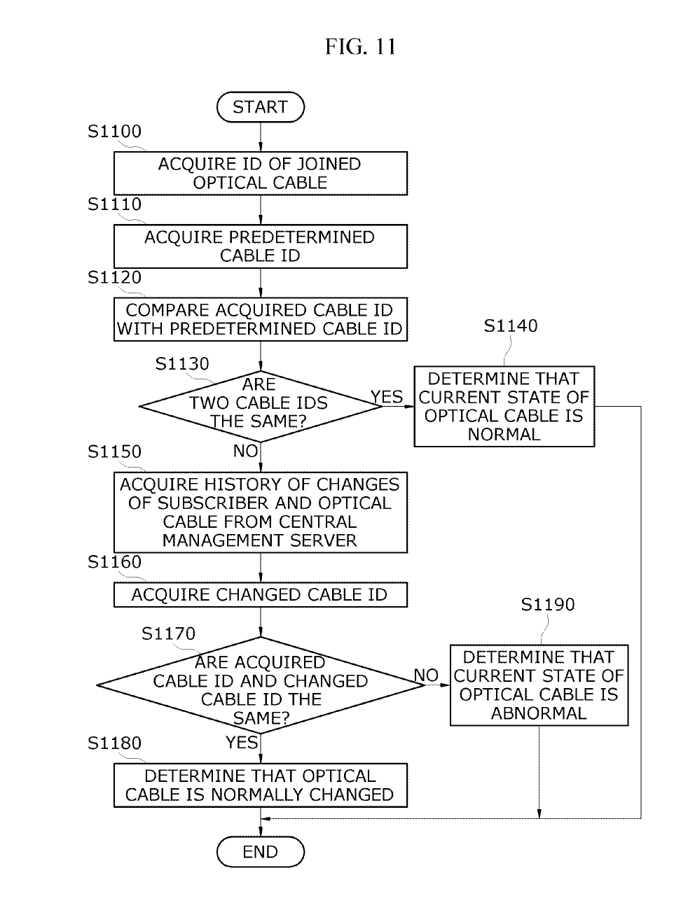

The processing module 220 will be described with reference to FIG. 10, which shows a configuration of a processing module of an optical node according to an embodiment of the present invention.

As can be seen from FIG. 10, the processing module 220 of the present invention includes a first recognition module 221, a second recognition module 222, a monitoring module 223, a distribution module 224, a central processing module 225, an external interface 226, and a power supply unit 227.

Also, the optical adaptors 210 and 210′ may be connected to the first and second recognition modules 221 and 222, and the first and second recognition modules 221 and 222 may acquire identification information from the optical connectors 110 and 110′ and provide the acquired identification information to the central processing module 225.

In this case, one of the first and second recognition modules 221 and 222 is connected to an optical cable connected to a subscriber terminal device (e.g., an ONT), and the other of the first and second recognition modules 221 and 222 is connected to an optical cable connected to a service provider (e.g., an OLT).

Also, each of the first and second recognition modules 221 and 222 may be provided as a plurality depending on branching functions of the optical node 200.

Also, the first and second recognition modules 221 and 222 acquire information regarding whether an optical cable is joined to the optical node 200 and identification information (a cable ID) of the joined optical cable and provide the information and the identification information to the central processing module 225.

The monitoring module 223 is configured to acquire state information of the optical cables 100 and 100′ and is based on a photodiode (PD).

Specifically, the monitoring module 223 may be implemented to perform a function of determining the presence of an optical signal or a function of measuring power of the optical signal as well as the function of determining the presence of the optical signal.

In this case, depending on functions, the monitoring module 223 may be composed of two elements, i.e., an element for performing the function of determining the presence of an optical signal and an element for performing the function of measuring power of the optical signal.

Also, data generated by the monitoring module 223 performing the functions, i.e., optical signal presence/absence information and optical signal power information, is provided to the central processing module 225.

A conventional optical time-domain reflectometer (OTDR) apparatus is very expensive because the OTDR apparatus includes expensive components to detect points (within a tolerance range of several centimeters to several meters) at which an optical cable is cut, cracked, or bent.

In actual optical network management, however, it is preferable to find an optical cable to which a subscriber is connected to transmit or receive data or an optical cable which has defects rather than use an expensive OTDR apparatus that accurately finds defective points.

Accordingly, by using the monitoring module 223, which is based on a photodiode (PD), according to the present invention, it is possible to acquire state information of an optical cable, which is needed for actual optical network management, at low cost.

As a method of acquiring state information of an optical cable using a PD, a method of branching an optical cable (e.g., at a ratio of 1:99), adhering the PD to an end of the branched optical cable, and measuring an optical signal, and a method of forming a crack and a method forming an artificial crack on optical fiber cladding and measuring an optical signal leaked through the crack may be used. In addition, various measuring methods may be used.

The distribution module 224 is configured to branch or distribute a joined optical cable. For example, the distribution module 224 may be implemented as a splitter PLC chip, which is widely used in the technical field of the present invention. Thus, a detailed description thereof will be omitted.

The central processing module 225 controls the first and second recognition modules 221 and 222 and the monitoring module 223 and manages various kinds of information generated by the modules.

The central processing module 225 includes a memory 225a that stores information of the first and second recognition modules 221 and 222, information of the monitoring module 223, and unique information (e.g., installation information, specification information, etc.) of the optical node 200.

Also, the central processing module 225 may receive information regarding whether the optical cable is joined to the optical node 200 and identification information of the joined optical cable from the first recognition module 221 and the second recognition module 222, and may manage a state of the optical cable.

In this case, the central processing module 225 may compare identification information of a currently joined optical cable with identification information of a previously joined optical cable. When there is a difference therebetween, the central processing module 225 may receive a history of changes of a subscriber and an optical cable from a central management server and determine whether the optical cable is normally joined to the optical node 200.

For example, the central processing module 225 finds identification information of an optical cable that is to be joined to the optical node 200 in the history of changes of a subscriber and an optical cable, which is received from the central management server, and determines whether the optical cable is normally joined to the optical node 200 when the found identification information of the optical cable is the same as the identification information of the currently joined optical cable.

Conversely, when the found identification information of the optical cable is not the same as the identification information of the currently joined optical cable, the central processing module 225 determines that the optical cable is not normally joined to the optical node 200.

Also, the central processing module 225 analyzes optical signal presence/absence information originating from the monitoring module 223 in addition to the history of changes of a subscriber and an optical cable, which originates from the central management server, to analyze whether a current state is normal or abnormal.

For example, when previous optical signal presence/absence information for a specific optical cable is the same as current optical signal present information for the specific optical able, the central processing module 225 may determine that the current state of the optical cable is normal.

Conversely, when the previous optical signal presence/absence information for the specific optical cable indicates that there is no optical signal (e.g., “0”) and the current optical signal presence/absence information for the specific optical cable indicates that there is an optical signal (e.g., “1”), that is, when the previous optical signal presence/absence information for the specific optical cable is not the same as the current optical signal presence/absence information for the specific optical cable, the central processing module 225 may acquire the history of changes of a subscriber and an optical cable from the central management server and check whether the current state is normal.

In case in which the previous optical signal presence/absence information for the specific optical cable is not the same as the current optical signal presence/absence information for the specific optical cable as described above, the central processing module 225 determines that the current state of the optical cable is normal when there is a history of changes of a subscriber and an optical cable and determines that the current state of the optical cable is abnormal when there is no history of changes of a subscriber and an optical cable.

Also, the central processing module 225 may analyze current state information of the optical cable by comparing current optical signal power information originating from the monitoring module 223 with previous optical signal power information that is within a normal range.

In this case, the optical signal power information within the normal range may be prestored in the memory 225a of the central processing module 225 or may be received from the central management server.

That is, since optical power varies depending on states such as a length of an optical cable, a connection or disconnection of a subscriber terminal device, and a bending, cutting, and cracking of an optical cable, the central processing module 225 may find the current state of the optical cable by comparing the current optical signal power information with optical signal power information that is within a normal range for each of the states.

The external interface 226, which is an interface for communicating with a central management server that manages the entirety of an ODN, may have a wireless communication (e.g., Wi-Fi, Bluetooth, Zigbee, etc.) module or a wired communication (e.g., Ethernet, serial communications, etc.) module.

Furthermore, the external interface 226 may have a wired/wireless communication module for communicating with the central management server using a function of tethering with an external portable device (e.g., a smartphone, a personal digital assistant (PDA), etc.).

The power supply unit 227 supplies power to electronic devices included in the optical node 200. In addition, the electronic devices included in the optical node 200 may receive power from an external battery and a wired tethering device which are connected to the external interface 226.

The structures and functions of the optical node and the optical connector that are used in the ODN according to an embodiment of the present invention have been described above. An operation of the optical node according to an embodiment of the present invention will be described in detail below.

FIG. 10 is a flowchart showing a procedure of analyzing a current state of an optical cable on the basis of information acquired by a recognition module of an optical node according to an embodiment of the present invention.

Referring to FIG. 10, while an optical cable is joined to an optical node, the recognition modules 221 and 222 of the optical node acquire identification information (cable ID) of the optical cable from an optical connector of the optical cable (S1100).

In this case, the cable ID acquired by the recognition modules 221 and 222 is provided to the central processing module 225.

After S1100, the central processing module 225 acquires a predetermined cable ID from the storage unit 225a or a central management server (S1110), compares the acquired cable ID with the predetermined cable ID (S1120), and determines whether the two cable IDs are the same.

When the determination result in S1130 is that the two cable IDs are the same (yes in S1130), the central processing module 225 determines that a current state of the optical cable is normal (S1140).

When the determination result in S1130 is that the two cable IDs are not the same (no in S1130), the central processing module 225 acquires a history of changes of a subscriber and an optical cable from the central management server (S1150) and checks a changed cable ID (S1160).

Subsequently, the central processing module 225 determines whether the acquired cable ID is the same as the changed cable ID (S1170).

When the determination result in S1170 is that the acquired cable ID is the same as the changed cable ID (yes in S1170), the central processing module 225 determines that the optical cable is normally changed (S1180). When the determination result is that the acquired cable ID is not the same as the changed cable ID (no in S1170), the central processing module 225 determines that the current state of the optical cable is abnormal (S1190).

That is, the central processing module 225 may find the current state of the optical cable by comparing the identification information of the optical cable acquired in S1100 with previous identification information of the optical cable.

In addition, the central processing module 225 may convert the acquired identification information and the found state of the optical cable into text, which has a form that may be directly recognized by a field engineer, and may provide the text to the central management server or a predetermined external portable device which is linked with the optical node 200.

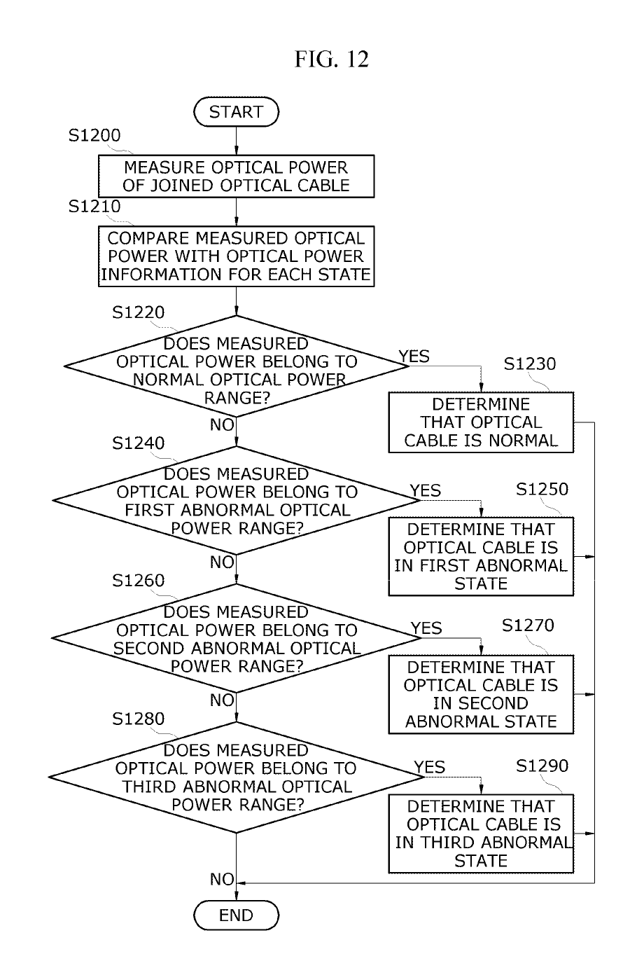

FIG. 12 is a flowchart showing a procedure of analyzing a current state of an optical cable on the basis of power information of an optical signal acquired by a monitoring module of an optical node according to an embodiment of the present invention.

Referring to FIG. 12, while an optical cable is joined to an optical node, the monitoring module 223 of the optical node measures optical power of the joined optical cable (S1200). In this case, the optical power measured by the monitoring module 223 is provided to the central processing module 225.

Also, the central processing module 225 compares the measured optical power with optical power information predetermined for each condition (S1210). In this case, the optical power information for each condition may be prestored in the memory 225a of the central processing module 225 or may be acquired from a central management server.

On the basis of the comparison result in S1210, the central processing module 225 determines an optical power range in a condition to which the measured optical power belongs.

Specifically, the central processing module 225 determines whether the measured optical power belongs to a normal optical power range (S1220) and, when the measured optical power belongs to the normal optical power range (yes in S1220), determines that the state of the optical cable is normal (S1230).

Conversely, when the measure optical power does not belong to the normal optical power range (no in S1220), the central processing module 225 determines whether the measured optical power belongs to an optical power range of a first abnormal state (hereinafter referred to as a “first abnormal optical power range”) (S1240).

In S1240, the first abnormal state may be a state in which a subscriber terminal device (an ONT) is connected to the optical cable but is powered off.

When the determination result in S1240 is that the measured optical power belongs to the first abnormal optical power range (yes in S1240), the central processing module 225 determines that the optical cable is in the first abnormal state (S1250).

When the determination result in S1240 is that the measured optical power does not belong to the first abnormal optical power range (no in S1240), the central processing module 225 determines that the measured optical power belongs to an optical power range for a second abnormal state (hereinafter referred to as a “second abnormal optical power range”) (S1260).

In S1260, the second abnormal state may be a state in which the optical cable is not connected to the subscriber terminal device.

When the determination result in S1260 is that the measured optical power belongs to the second abnormal optical power range (yes in S1260), the central processing module 225 determines that the optical cable is in the second abnormal state (S1270).

Also, when the determination result in S1260 is that the measured optical power does not belong to the second abnormal optical power range (no in S1260), the central processing module 225 determines that the measured optical power belongs to an optical power range for a third abnormal state (hereinafter referred to as a “third abnormal optical power range”) (S1280).

In S1280, the third abnormal state may be a state in which the optical cable is cut or bent.

When the determination result in S1280 is that the measured optical power belongs to the third abnormal optical power range (yes in S1280), the central processing module 225 determines that the optical cable is in the third abnormal state (S1290).

Conversely, when the determination result in S1280 is that the measured optical power does not belong to the third abnormal optical power range (no in S1280), the central processing module 225 ends an operation of analyzing the current state of the optical cable.

FIG. 12 illustrates an example in which the central processing module 225 analyzes four states of the optical cable. However, it should be understood by those skilled in the art that the state of the optical cable may be analyzed in more detail by subdividing conditions.

That is, the central processing module 225 may find various states of the optical cable by comparing the measured optical power with the optical power information predetermined for each condition in S1210.

In addition, the central processing module 225 may convert the measured optical power and the found states of the optical cable into text, which has a form that may be directly recognized by a field engineer, and may provide the text to the central management server or a predetermined external portable device which is linked with the optical node 200.

Also, the optical node 200 includes a display device such as an LED matching the optical cable, and the central processing module 225 may be implemented to display a current state of the optical cable through the display device.

For example, the central processing module 225 may be implemented to light or blink LEDs of different colors according to the state of the optical cable. The central processing module 225 may be implemented to light a green LED in the normal state, light a yellow LED in the first abnormal state, light a red LED in the second abnormal state, and blink the LEDs in the third abnormal state.

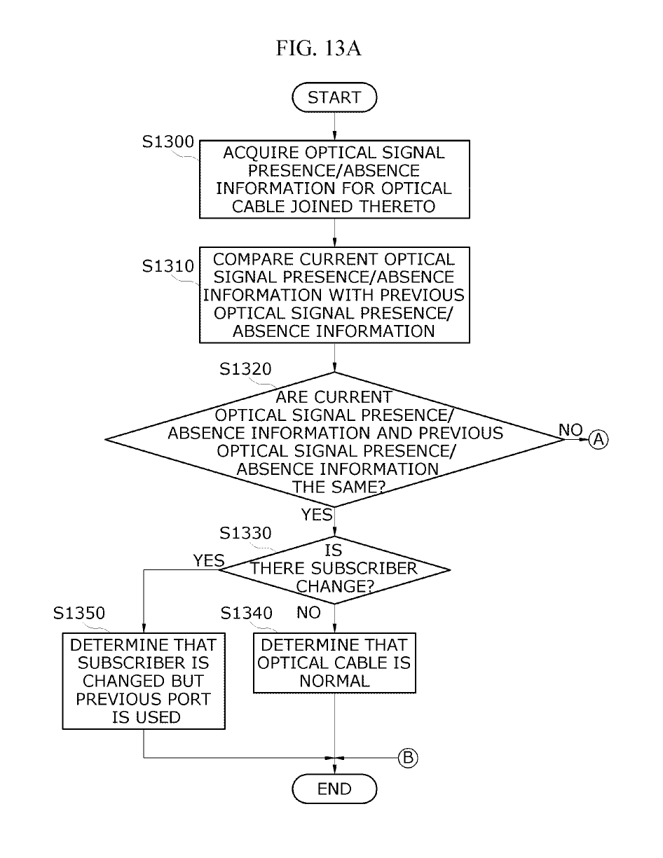

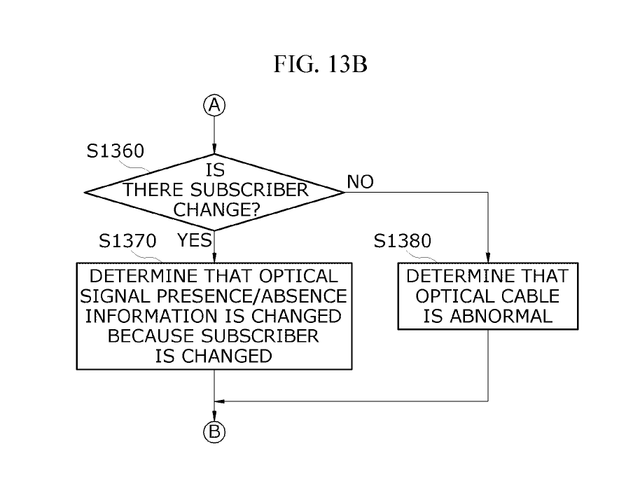

FIGS. 13A and 13B are flowcharts showing a procedure of analyzing a current state of an optical cable on the basis of optical signal presence/absence information acquired by a monitoring module of an optical node according to an embodiment of the present invention.

Referring to FIGS. 13A and 13B, while an optical cable is joined to an optical node, the monitoring module 223 of the optical node acquires optical signal presence/absence information of the joined optical cable (S1300). In this case, the optical signal presence/absence information acquired by the monitoring module 223 is provided to the central processing module 225.

Also, the central processing module 225 compares the current optical signal presence/absence information with previous optical signal presence/absence information (S1310) and determines whether the current optical signal presence/absence information and the previous optical signal presence/absence information are the same (S1320).

When the determination result in S1320 is that the current optical signal presence/absence information and the previous optical signal presence/absence information are the same (yes in S1320), the central processing module 225 determines whether a subscriber is changed on the basis of a history of changes of a subscriber and an optical cable provided by a central management server (S1330).

When the determination result in S1330 is that there is no subscriber change (no in S1330), the central processing module 225 determines that the optical cable is normal (S1340).

Conversely, when the determination result in S1330 is that there is a subscriber change (yes in S1330), the central processing module 225 determines that a port that was used by a previous subscriber is used although the subscriber is changed (S1350).

When the determination result in S1320 is that the current optical signal presence/absence information and the previous optical signal presence/absence information are not the same (no in S1320), the central processing module 225 determines whether a subscriber is changed on the basis of the history of changes of a subscriber and an optical cable provided by the central management server (S1360).

When the determination result in S1360 is that there is a subscriber change (yes in S1360), the central processing module 225 determines that the optical signal presence/absence information is changed when the subscriber is changed (S1370).

Conversely, when the determination result in S1360 is that there is no subscriber change (no in S1360), the central processing module 225 determines that the optical cable is abnormal (i.e., that the optical signal presence/absence information is changed, but the subscriber information is not changed) (S1380).

That is, the central processing module 225 may find the current state of the optical cable by comparing the optical signal presence/absence information acquired in S1300 with previous optical signal presence/absence information from the optical cable.

In addition, the central processing module 225 may convert the acquired optical signal presence/absence information and the found state of the optical cable into text, which has a form that may be directly recognized by a field engineer, and may provide the text to the central management server or a predetermined external portable device which is linked with the optical node 200.

According to the configuration of the present invention, it is possible for a processing module of an optical node to acquire identification information of an optical cable and determine a state of the optical cable on the basis of the identification information by being joined to a connector that stores the identification information of the optical cable.

Also, it is possible for the processing module of the optical node to acquire optical signal presence/absence information and optical power information for an optical cable being joined thereto and determine a state of the optical cable on the basis of the optical signal presence/absence information and optical power information.

Accordingly, it is possible to efficiently manage an optical infrastructure because the optical node of the present invention may acquire and analyze various kinds of information associated with the optical cable while a conventional optical node just performs a passive function for optical distribution.

The ODN including an optical cable and an optical node and the operating method thereof according to the present invention have been described with reference to example embodiments. However, the present invention is not limited to the example embodiment, and it should be obvious to those skilled in the art that various alternatives, modifications, and variations can be made therein without departing from the spirit and scope of the present invention.

Accordingly, the embodiments and the accompany drawings of the present invention are to be considered in a descriptive sense only and not for purposes of limitations, and do not limit the sprit of the invention. The scope of the invention should be construed by the appended claims, and all technical ideas within the scope of their equivalents should be construed as being included in the scope of the invention.

What is claimed is:

1. An optical distribution network (ODN) including an optical cable and an optical node connectable to the optical cable, wherein:
the optical cable has an optical connector capable of being joined to the optical node; and
the optical connector has an electronic tag configured to store identification information of the optical cable and a first connection pin configured to electrically connect the electronic tag and the optical node.

2. The ODN of claim 1, wherein the electronic tag and the first connection pin are directly formed in a body of the optical connector.

3. The ODN of claim 1, wherein the electronic tag and the first connection pin are formed in the optical connector by adhering an auxiliary object having the electronic tag and the first connection pin formed therein to a body of the optical connector.

4. The ODN of claim 1, wherein the optical node comprises:
an optical adaptor capable of being joined to the optical connector; and
a processing module configured to determine a state of the optical cable using at least one of the identification information of the optical cable having the optical connector capable of being joined to the optical adaptor, optical signal presence/absence information, and optical power information.

5. The ODN of claim 4, wherein the optical adaptor comprises:
a second connection pin connectable to the first connection pin at one end thereof; and
a connection part connected to the other end of the second connection pin at one end thereof and connected to the processing module at the other end thereof.

6. The ODN of claim 4, wherein the processing module comprises:
at least one recognition module connected to the optical adaptor and configured to acquire the identification information of the optical cable from the optical connector joined to the optical adaptor;
a monitoring module configured to acquire optical signal presence/absence information of the optical cable connected through the optical adaptor and measure the optical power information; and
a central processing module configured to determine the state of the optical cable using at least one of the identification information, the optical signal presence/absence information, and the optical power information.

7. The ODN of claim 6, wherein the central processing module compares current identification information with predetermined identification information, determines that the current state of the optical cable is normal when the current identification information and the predetermined identification information are the same, acquires a history of changes of a subscriber and an optical cable from a central management server when the current identification information and the predetermined identification information are not the same, determines that the optical cable is normally changed when the current identification information and identification information included in the history of changes are the same, and determines that the current state of the optical cable is abnormal when the current identification information and identification information included in the history of changes are not the same.

8. The ODN of claim 6, wherein the central processing module compares the measured optical power information with optical power information for each state and determines the current state of the optical cable.

9. The ODN of claim 8, wherein the central processing module determines whether the current state of the optical cable is normal, whether a subscriber terminal device is connected to the optical cable but is powered off, whether a subscriber terminal device is not connected to the optical cable, or whether the optical cable is cut or bent by comparing the measured optical power information with the optical power information for each state.

10. The ODN of claim 6, wherein the central processing module compares the acquired optical signal presence/absence information with previous optical signal presence/absence information, acquires a history of changes of a subscriber and an optical cable from a central management server when the acquired optical signal presence/absence information and the previous optical signal presence/absence information are the same, determines that a subscriber is changed but a previous port is used when there is a subscriber change, and determines that the optical cable is normal when there is no subscriber change.

11. The ODN of claim 10, wherein the central processing module compares the acquired optical signal presence/absence information with the previous optical signal presence/absence information, acquires the history of changes of a subscriber and an optical cable from the central management server when the acquired optical signal presence/absence information and the previous optical signal presence/absence information are not the same, determines that the acquired optical signal presence/absence information is changed when there is a subscriber change, and determines that the optical cable is abnormal when there is no subscriber change.

12. The ODN of claim 4, wherein:
the optical adaptor comprises:
a space formed at any one surface of a body of the optical adaptor to which the optical connector is to be joined; and
a circuit board having a second connection pin installed therein and having a wire configured to electrically connect the second connection pin and the processing module; and
the circuit board is adhered to the body of the optical adaptor so that the second connection pin is positioned in the space.

13. The ODN of claim 1, wherein:
the optical connector comprises:
a body; and
a housing coupled to the body and capable of being joined to the optical adaptor; and
the electronic tag and the first connection pin are formed in the housing.

14. An operating method of an optical distribution network (ODN) including an optical cable and an optical node connectable to the optical cable, the operating method comprising:
acquiring information regarding the optical cable while the optical cable is joined to the optical node, by a processing module of the optical node;
comparing the acquired information regarding the optical cable with previous information regarding the optical cable and determining a current state of the optical cable, by the processing module; and
providing the acquired information regarding the optical cable and a result of the determination to a central management server or a predetermined external portable device that is linked with the optical node, by the processing module.

15. The operating method of claim 14, wherein:
the acquiring of information regarding the optical cable comprises acquiring identification information of the optical cable, by the processing module; and
the determining of a current state of the optical cable comprises comparing current identification information with predetermined identification information and determining that the current state of the optical cable is normal when the current identification information and the predetermined identification information are the same.

16. The operating method of claim 15, wherein the determining of a current state of the optical cable comprises: acquiring a history of changes of a subscriber and an optical cable from the central management server when the current identification information and the predetermined identification information are not the same, determining that the optical cable is normally changed when the current identification information and identification information included in the history of changes are the same, and determining that the current state of the optical cable is abnormal when the current identification information and identification information included in the history of changes are not the same.

17. The operating method of claim 14, wherein:
the acquiring of information regarding the optical cable comprises acquiring optical signal presence/absence information for the optical cable, by the processing module; and
the determining of a current state of the optical cable comprises comparing the acquired optical signal presence/absence information with previous optical signal presence/absence information, acquiring a history of changes of a subscriber and an optical cable from the central management server when the acquired optical signal presence/absence information and the previous optical signal presence/absence information are the same, determining that a subscriber is changed but a previous port is used when there is a subscriber change, and determining that the optical cable is normal when there is no subscriber change.

18. The operating method of claim 17, wherein the determining of a current state of the optical cable comprises comparing the acquired optical signal presence/absence information with the previous optical signal presence/absence information, acquiring the history of changes of a subscriber and an optical cable from the central management server when the acquired optical signal presence/absence information and the previous optical signal presence/absence information are not the same, determining that the acquired optical signal presence/absence information is changed when there is a subscriber change, and determining that the optical cable is abnormal when there is no subscriber change.

19. The operating method of claim 14, wherein:
the acquiring of information regarding the optical cable comprises measuring optical power information for the optical cable, by the processing module; and
the determining of a current state of the optical cable comprises comparing the measured optical power information with optical power information for each state to determine the current state of the optical cable.

20. The operating method of claim 19, wherein the determining of a current state of the optical cable comprises determining whether the current state of the optical cable is normal, whether a subscriber terminal device is connected to the optical cable but is powered off, whether a subscriber terminal device is not connected to the optical cable, or whether the optical cable is cut or bent by comparing the measured optical power information with the optical power information for each state.
